(19) United States
(12) Patent Application Publication
(10) Pub. No.: US 2023/0013439 A1
(43) Pub. Date: Jan. 19, 2023

(54) FORCE SENSOR DEVICE

(71) Applicant: ALPS ALPINE CO., LTD., Tokyo (JP)

(72) Inventors: Takashi NAKAI, Fukushima (JP); Kazunori NAKANO, Miyagi (JP)

(21) Appl. No.: 17/936,452

(22) Filed: Sep. 29, 2022

Related U.S. Application Data
(63) Continuation of application No. PCT/JP2021/017587, filed on May 7, 2021.

(30) Foreign Application Priority Data
May 13, 2020 (JP) 2020-084769

(51) Int. Cl. G01L 3/10

(52) U.S. Cl. CPC G01L 3/108

(57) ABSTRACT

A force sensor device includes a strain generator including a first fixed part secured to a portion transmitting rotational driving force or a portion to which the rotational driving force is transmitted, a second fixed part secured to the portion to which the driving force is transmitted or the portion transmitting the driving force, and a joining part that joins the first fixed part to the second fixed part; a strain detecting sensor that detects deformation in the joining part; and a support member provided with a base secured to the second fixed part, wherein the support member includes a regulator and a protrusion, and wherein, in a support part of the first fixed part, a groove is formed by cutting the support part from an inner surface in a radial direction toward an outer surface, and the protrusion of the support member is inserted into the groove.

### CROSS-REFERENCE TO RELATED APPLICATIONS

The present application is a continuation application filed under 35 U.S.C. 111(a) claiming benefit under 35 U.S.C. 120 and 365(c) of PCT International Application No. PCT/JP2021/017587 filed on May 7, 2021, designating the U.S., which claims priority based on Japanese Patent Application No. 2020-084769, filed on May 13, 2020. The entire contents of each of the foregoing applications are incorporated herein by reference.

### TECHNICAL FIELD

The present disclosure relates to a force sensor device.

### BACKGROUND

In recent years, a torque sensor provided with a disk-shaped strain generator and a strain gauge have been used in a joint part of a robot. As a strain generator, a strain generator provided with an annular outer fixed part, an inner fixed part disposed inside the outer fixed part, and a joining part that joins the outer fixed part and the inner fixed part has been known. In such a torque sensor, the strain generator is disposed perpendicular to a rotation axis, and a rotating body (e.g., the rotation axis or a robot arm) is secured to the outer fixed part and to the inner fixed part. A torque applied to the strain generator is detected by detecting a strain in the joining part generated by the rotation of the rotating body by using the strain gauge. In such a torque sensor, an annular first region and an annular second region is connected by using a beam, and a strain gauge is disposed in a portion of the beam. The torque sensor that is integrally formed of a metal has been known (see Patent Document 1, for example).

### RELATED ART DOCUMENT

### [Patent Document]

[Patent Document 1] Japanese Patent Application Publication No. 2019-158419

### SUMMARY

There is a need for a force sensor device that has sufficient strength and that has sufficient sensitivity for a low torque.

A force sensor device according to an embodiment includes a strain generator including a first fixed part secured to a portion transmitting rotational driving force or a portion to which the rotational driving force is transmitted, a second fixed part secured to the portion to which the driving force is transmitted or the portion transmitting the driving force, and a joining part that joins the first fixed part to the second fixed part; and a strain detecting sensor that detects deformation in the joining part of the strain generator, wherein the first fixed part is disposed outside the second fixed part across the joining part, wherein the force sensor device further includes a support member provided with a base secured to the second fixed part, wherein the support member includes a regulator extending from the base, wherein the support member is provided with a protrusion at an outer circumferential edge of the regulator, wherein, in a support part that is a partially raised portion of the first fixed part, a groove is formed by cutting the support part from an inner surface in a radial direction toward an outer surface in the radial direction, and wherein the protrusion of the support member is inserted into the groove.

### BRIEF DESCRIPTION OF THE DRAWINGS

FIG. 1 is a perspective view of an external appearance of a force sensor device according to an embodiment.

FIG. 2 is a plan view of the force sensor device according to an embodiment.

FIG. 3 is an exploded perspective view of the force sensor device according to an embodiment.

FIG. 4 is a cross sectional view of the force sensor device according to an embodiment.

FIG. 5 is a plan view illustrating a strain generator according to an embodiment.

FIG. 6 is an enlarged view of a portion of the strain generator according to an embodiment.

FIG. 7 is a partially enlarged cross sectional view of the force sensor device according to an embodiment.

### DETAILED DESCRIPTION OF EMBODIMENTS

The force sensor device described in Patent Document 1 is too heavy to meet the demand for weight reduction because the force sensor device is integrally formed by the metal. Furthermore, the force sensor device described in Patent Document 1 has low sensitivity upon reception of a torque, and the force sensor device is unable to obtain a sufficient accuracy for a low torque. In this regard, the force sensor device described in Patent Document 1 may be able to meet the demand for the weight reduction or obtain sufficient sensitivity upon reception of a low torque by changing the base material to a synthetic resin material or reducing the thickness. In this case, however, the overall strength against torque is not sufficiently obtained.

According to an embodiment, a torque sensor device can be provided that has sufficient strength and that that has sufficient sensitivity to a low torque.

In the following, embodiments of the present disclosure are described with reference to the accompanying drawings. With regard to the description and drawings of each embodiment, duplicate descriptions are omitted by assigning identical reference numerals to components having substantially identical functional configurations.

(Configuration of the Force Sensor Device 100)

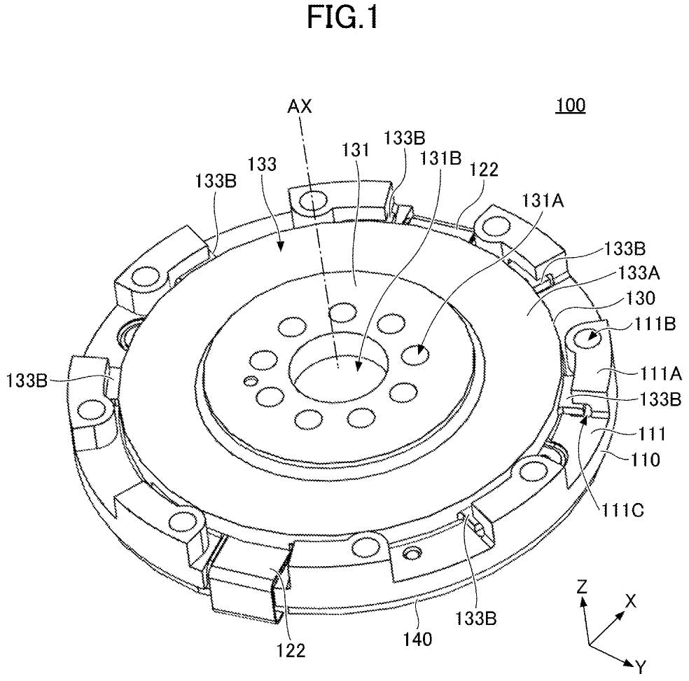

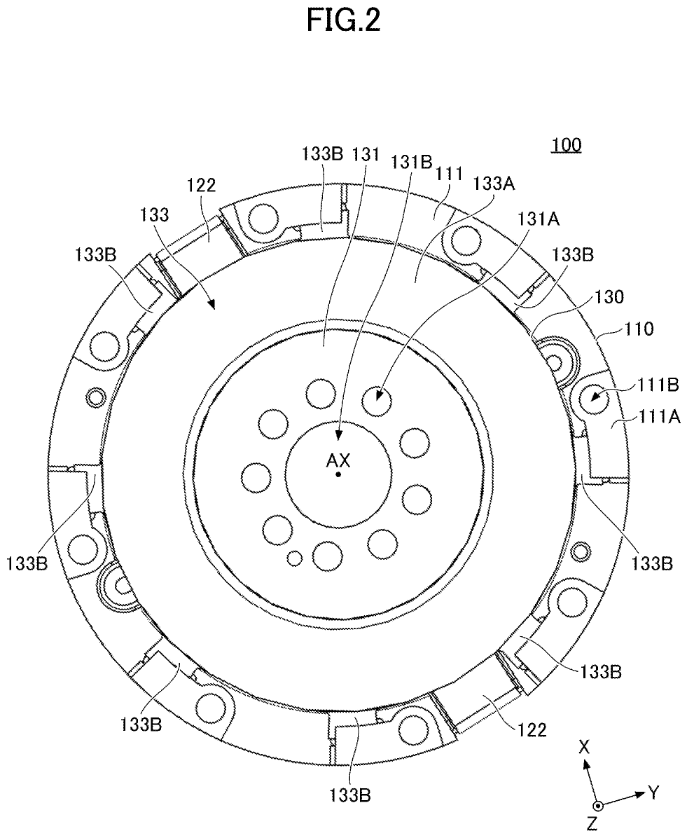

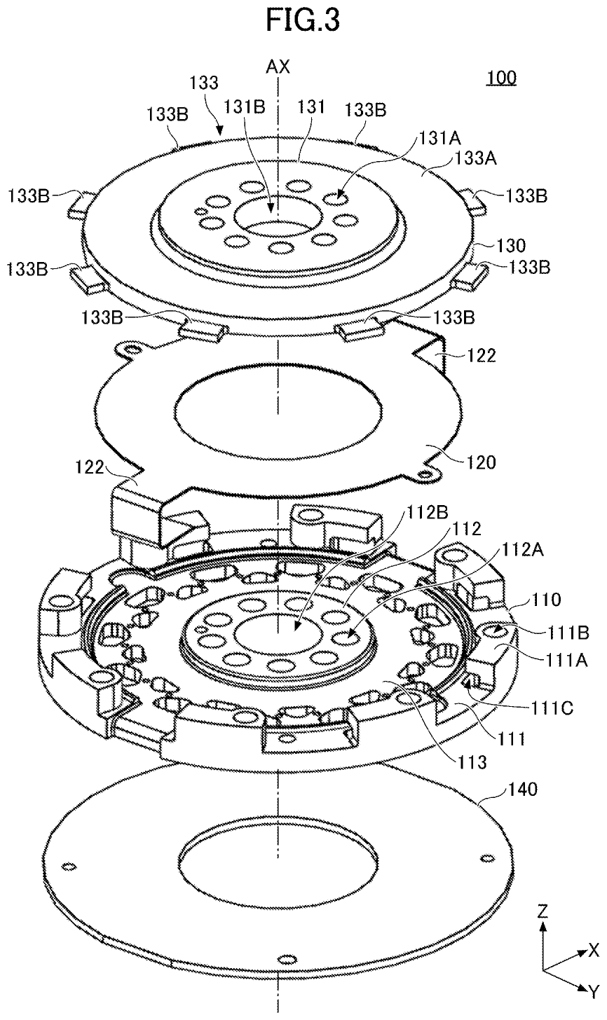

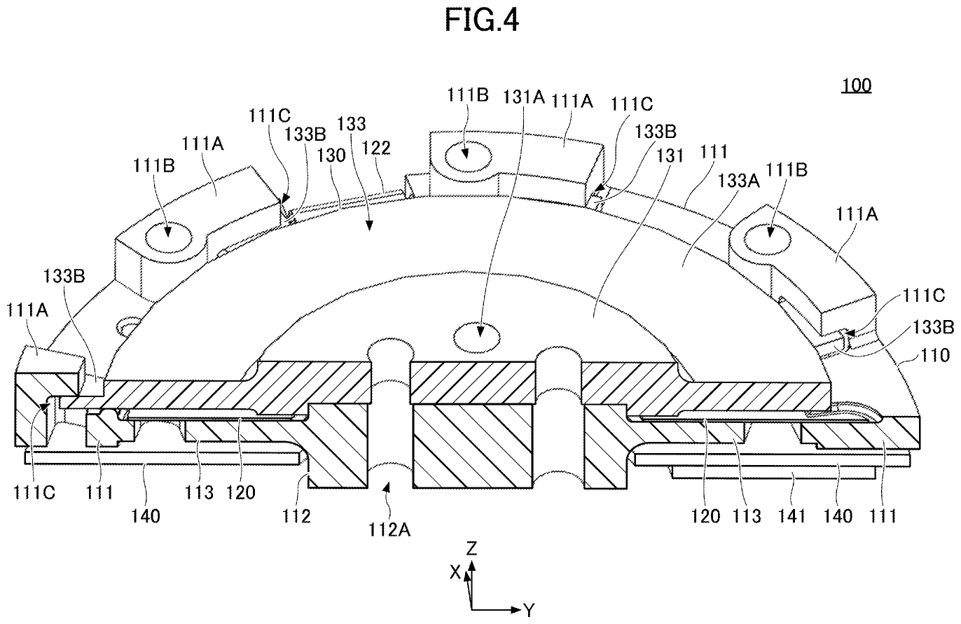

FIG. 1 is a perspective view of an external appearance of a force sensor device 100 according to an embodiment. FIG. 2 is a plan view of the force sensor device 100 according to an embodiment. FIG. 3 is an exploded perspective view of the force sensor device 100 according to an embodiment. FIG. 4 is a cross sectional view of the force sensor device 100 according to an embodiment.

For convenience, the direction of a rotation axis AX is referred to as a vertical direction (a Z axis direction) in the following descriptions. Directions perpendicular to the rotation axis AX is defined as an X-axis direction and a Y-axis direction. The X-axis direction and Y-axis direction are perpendicular to each other.

The force sensor device 100 illustrated in FIG. 1 through FIG. 4 is a disk-shaped sensor that detects a torque. The force sensor device 100 is mounted perpendicular to the rotation axis AX at a joint part or the like of a robot. The force sensor device 100 detects a rotational torque applied to a strain generator 110 by detecting the strain of the strain generator 110 by using a strain detecting sensor 121.

As illustrated in FIG. 1 through FIG. 4, the force sensor device 100 is formed to include the strain generator 110, a flexible board 120, a support member 130, and a circuit board 140.

The strain generator 110 is a disk-shaped member to which a torque is applied by the rotation of the rotating body. The strain generator 110 is formed by using a resin material, such as Poly Phenylene Ether (PPE). The strain generator 110 is provided with a first fixed part 111, a second fixed part 112, and a joining part 113.

The first fixed part 111 is an annular part centered on the rotation axis AX and located outside the strain generator 110. In the first fixed part, multiple (8 in this example) support parts 111A are formed on the same circumference. The support parts 111A are partially raised portions. In each of the multiple (8 in this example) support parts 111A, a through hole 111B that penetrates the support part 111A in the vertical direction is famed. That is, in the first fixed part 111, multiple (8 in this example) through holes 111B penetrating the respective first fixed parts 111 in the vertical direction are formed on the same circumference. The first fixed part 111 is fixed to one of a transmitting member for transmitting the rotational driving force or a transmitted member to which the rotational driving force is transmitted by multiple bolts passing through the multiple through holes 111B.

Furthermore, each of the multiple support parts 111A has a groove 111C formed by cutting the support parts 111A with a constant vertical width from an inner surface in the radial direction toward an outer surface in the radial direction. In the groove 111C, a protrusion 133B of a regulator 133 formed at an outer circumferential edge of the support member 130 is inserted. The groove 111C opens in the direction of rotation, and by rotating the support member 130, the protrusion 133B of the regulator 133 can be inserted into the support member 130 from the opening. The vertical width of the grooves 111C has the same size as the vertical width of the protrusions 133B of the regulator 133. Accordingly, the groove 111C holds the protrusion 133B of the regulator 133 while regulating the vertical movement of the protrusion 133B of the regulator 133.

The second fixed part 112 is an annular part centered on the rotation axis AX and located inside the strain generator 110. The outer diameter of the second fixed part 112 is smaller than the inner diameter of the first fixed part 111. In the second fixed part 112, multiple (8 in this example) through holes 112A passing through the second fixed part 112 in the vertical direction are formed on the same circumference. The second fixed part 112 is secured to the other of the transmitting member for transmitting the rotational driving force and the transmitted member to which the rotational driving force is transmitted by the multiple bolts passing through the multiple through holes 112A. The second fixed part 112 has a circular through hole 112B at the center. The through hole 112B is formed so that wiring can pass through the through hole 112B.

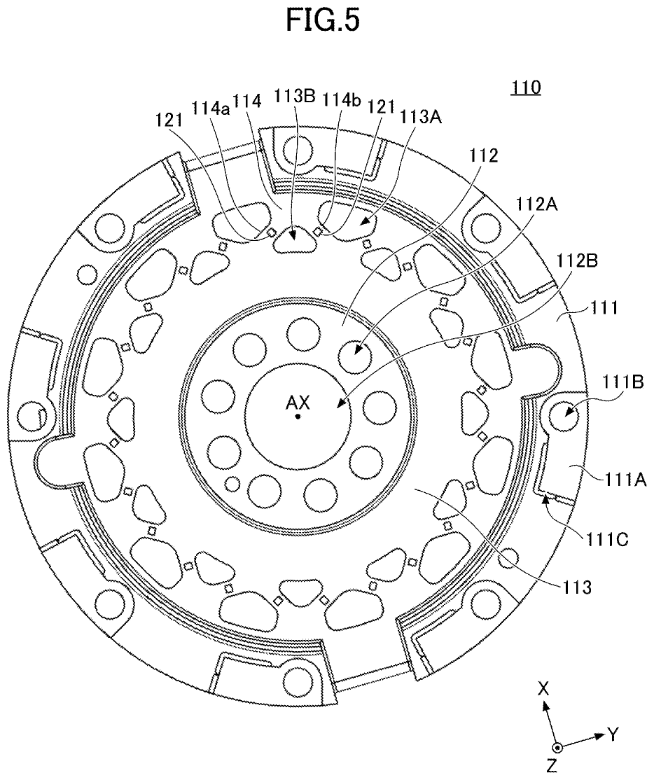

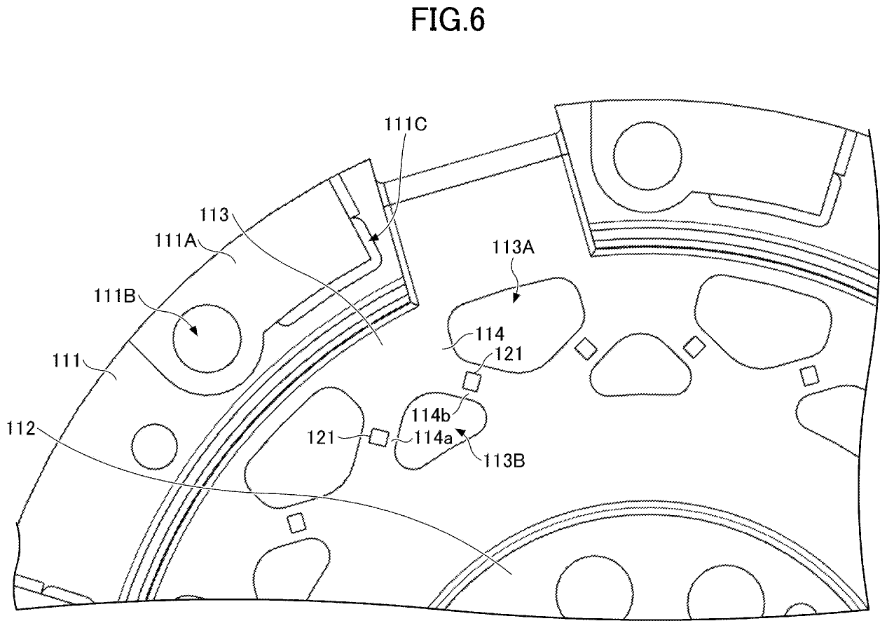

The joining part 113 is an annular part centered on the rotation axis AX and joining the first fixed part 111 to the second fixed part 112 (i.e., the joining part 113 is provided between the inner diameter of the first fixed part 111 and the outer diameter of the second fixed part 112). The joining part 113 is thinner than the first fixed part 111 and the second fixed part 112. In addition, the joining part 113 has rigidity lower than that of the first fixed part 111 and the second fixed part 112. The joining part 113 is the part where deformation occurs upon application of a torque to the force sensor device 100 by the rotation of the driving member fixed to the first fixed part 111 or the second fixed part 112. The force sensor device 100 can detect the rotational driving torque by detecting the deformation of the joining part 113. The detailed configuration of the joining part 113 is described below with reference to FIG. 5 and FIG. 6.

The support member 130 is a disk-shaped member that is stacked on the upper surface of the strain generator 110 while clamping the flexible board 120 between the support member 130 and the strain generator 110. The support member 130 is formed of a metal material or a resin material that has rigidity that is higher than that of the strain generator 110. The support member 130 enhances the multiaxial strength (strength against bending moment, axial load, and radial load) of the resin strain generator 110. The support member 130 is provided with a base 131 and the regulator 133.

The base 131 is formed at the center of the support member 130, and the base 131 is an annular portion centered on the rotation axis AX. Multiple circular through holes 131A are formed in the base 131 on the same circumference. The through hole 131A is famed so that the bolt that passes through the second fixed part 112 of the strain generator 110 can pass through the through hole 131A. The base 131 is secured to the second fixed part 112 of the strain generator 110 by the bolt that passes through the through hole 131A, and, at the same time, the base 131 is secured to the transmitting member for transmitting the rotational driving force or to the transmitted member to which the rotational driving force is transmitted. The base 131 also has a circular through hole 131B at the center. The through hole 131B is famed so that the wiring can pass through the through hole 131B.

The regulator 133 is provided with a flat plate part 133A and the multiple protrusions 133B. The flat plate part 133A is an annular part surrounding the base 131, and the flat plate part 133A is centered on the rotation axes AX. The flat plate part 133A is disposed to cover the joining part 113 of the strain generator 110 and the flexible board 120 stuck on the joining part 113. As illustrated in FIG. 4, the flat plate part 133A is parallel to the joining part 113, and a gap is provided between the flat plate part 133A and the joining part 113.

The multiple protrusions 133B are provided at the outer circumferential edge of the regulator 133. The protrusion 133B is a flat plate with a constant thickness that protrudes radially outward from the outer circumferential edge of the support member 130. The protrusion 133B is inserted into the groove 111C formed in the support 111A formed in the first fixed part 111 of the strain generator 110 by rotating and sliding the support member 130 in the circumferential direction. In this embodiment, 8 protrusions 133B are provided at equal intervals (that is, 45 degree intervals) at the outer circumferential edge of the support member 130. In accordance with this, in the embodiment, 8 support parts 111A are provided at equal intervals (that is, 45 degree intervals) in the first fixed part 111 of the strain generator 110.

As illustrated in FIG. 4, the vertical width of the groove 111C has the same size as the vertical width of the protrusion 133B. Accordingly, the movement in the vertical direction of the protrusion 133B is regulated in the groove 111C to suppress the vertical deformation (i.e., the defamation that should not be detected) of the strain generator 110 caused by the bending moment, the axial load, or the radial load applied to the strain generator 110. In this regard, the protruding portion 133B allows the deformation of the strain generator 110 in the rotation direction (i.e., the deformation to be detected) of the strain generator 110 by not regulating the movement in the rotation direction in the groove portion 111C.

As described above, the force sensor device 100 according to the embodiment uses a resin material for the strain generator 110, so that the strain generator 110 can be easily formed by injection molding or the like. In addition, the force sensor device 100 according to the embodiment can compensate for the decrease in the strength of the strain generator 110 due to the use of the resin material by providing the support member 130. Furthermore, the force sensor device 100 according to the embodiment can suppress the vertical deformation of the strain generator 110 by the protrusion 133B provided in the support member 130, and the force sensor device 100 can allow the defamation in the rotation direction of the strain generator 110. Thus, with the force sensor device 100 according to the embodiment, a force sensor can be provided that has sufficient accuracy for a low torque while ensuring sufficient strength.

The flexible board 120 is a thin film-like member that is installed on the upper surface of the joining part 113 of the strain generator 110. The flexible board 120 has an annular shape that is approximately the same as that of the joining part 113. The flexible board 120 is formed of an insulating material (e.g., polyimide). The flexible board 120 is attached to the upper surface of the joining part 113 of the strain generator 110 by an adhesive means (e.g., a glue). In the flexible board 120, multiple strain detecting sensors 121 and multiple pieces of wiring (not depicted) for connecting the multiple strain detecting sensors 121 and the circuit board 140 are implemented. In the flexible board 120, each of the multiple strain detecting sensors 121 is provided at a position corresponding to a beam portion 114a or a beam portion 114b (see FIG. 5 and FIG. 6) of the joining part 113 of the strain generator 110. The flexible board 120 has extended parts 122 extended outward from the outer circumferential edge. The extended part 122 is a part to connect multiple pieces of wire connected to the multiple strain detecting sensors 121 to the circuit board 140. The extended part 122 is orthogonally folded downward, and, subsequently, the extended part 122 is orthogonally folded inward. The extended part is connected to the circuit board 140. In the embodiment, the flexible board 120 is provided with a pair of the extended parts 122 facing each other with the rotation axis AX between them.

In the strain detecting sensor 121, a resistance value changes due to deformation (contraction and extension). The strain detecting sensor 121 is a sensor that detects deformation by using a change in the resistance value. The strain detecting sensor 121 is installed on the flexible board 120 at a position corresponding to the beam portion 114a or the beam portion 114b (see FIG. 5 and FIG. 6) of the joining part 113 of the strain generator 110. Accordingly, the strain detecting sensor 121 can detect deformation of the beam portion 114a or the beam portion 114b. As a result, a voltage value corresponding to an amount of the deformation of the beam portion 114a or the beam portion 114b (i.e., the amount of deformation of the strain detecting sensor 121) is output to the circuit board 140 via the flexible board 120. Note that, in FIG. 5 and FIG. 6, for convenience, the strain detecting sensors 121 are indicated at the beam portions 114a and the beam portions 114b of the joining part 113 of the strain generator 110 at which the strain detecting sensors 121 are to be located, instead of the corresponding position on the flexible board 120. In this embodiment, multiple strain detecting sensors 121 may be collectively formed on the flexible board 120 by carbon printing.

The circuit board 140 is a flat and annular member that is secured to the bottom surface of the strain generator 110. The circuit board 140 has electronic components such as an integrated circuit (IC) 141 (see FIG. 4) on its bottom surface. The IC 141 obtains output values from the respective multiple strain detecting sensors 121 via the flexible board 120. Subsequently, the IC 141 calculates a rotational torque applied to the strain generator 110 based on the output values from the respective multiple strain detecting sensors 121. For example, for each of the multiple beam portions 114 (see FIG. 5 and FIG. 6), the IC 141 calculates a difference between the output voltage value Va of the strain detecting sensor 121 provided at the beam portion 114a of the beam portion 114 and the output voltage value Vb of the strain detecting sensor 121 provided at the beam portion 114b of the beam portion 114. Subsequently, the IC 141 sums up the calculated differences at the respective multiple beam portions 114, and the IC 141 calculates the torque T by multiplying the sum total by a preconfigured coefficient k.

In the force sensor device 100 according to the embodiment, upon application of a torque to the strain generator 110, in each of the multiple beam portions 114, the beam portion 114a and the beam portion 114b are deformed in the directions opposite to each other. Namely, in the force sensor device 100 according to the embodiment, one of the beam portion 114a and the beam portion 114b shrinks, and, at the same time, the other of the beam portion 114a and the beam portion 114b extends. Here, the polarity of the change in the output voltage ΔVa and the polarity of the change in the output voltage ΔVb are different from each other, so that, if these changes are added, the changes in the voltage value V corresponding to the torque are cancelled. Accordingly, the force sensor device 100 according to the embodiment obtains the difference between the change of the output voltage ΔVa and the change of the output voltage ΔVb for each of the multiple beam sections 114, and the force sensor device 100 calculates the total of the differences. As a result, the force sensor device 100 according to the embodiment can calculate the total of the differences in the voltage V corresponding to the torque, and the force sensor device 100 according to the embodiment can calculate the torque corresponding to the total of the differences.

(Configuration of the Joining Part 113 of the Strain Generator 110)

FIG. 5 is a plan view of the strain generator 110 according to an embodiment. FIG. 6 is an enlarged view of a portion of the strain generator 110 according to an embodiment. FIG. 5 and FIG. 6 illustrate the arrangement positions of the multiple strain detecting sensors 121 on the top surface of the joining part 113 of the strain generator 110 by superimposing the multiple strain detecting sensors 121 on the top surface of the joining part 113 of the strain generator 110.

As illustrated in FIG. 5 and FIG. 6, the multiple through holes 113A are famed on the same circumference at the joining part 113 of the strain generator 110. As a result, the beam portions 114 are formed between the two through holes 113A adjacent to each other. The beam portions 114 connect the part radially outside the multiple through holes 113A in the joining part 113 and the part radially inside the multiple through holes 113 A in the joining part 113.

As illustrated in FIG. 5 and FIG. 6, in the joining part 113, a through hole 113B is famed on the rotation axis AX side of each of the multiple beam portions 114. Namely, in the joining part 113, multiple through-holes 113B are formed on the same circumference. As a result, each of the multiple beam portions 114 has 2 beam portions 114a and 114b branched on the rotation axis AX side with the through hole 113B between them.

As shown in FIG. 5 and FIG. 6, the strain detecting sensor 121 implemented on the flexible board 120 is disposed on the upper surface of each of the multiple beam portions 114a and 114b. In the joining part 113, each of the multiple beam portions 114a and 114b is narrower than the other parts, so that defamation is more likely to occur than the other parts. Accordingly, the force sensor device 100 according to the embodiment can detect the torque applied to the strain generator 110 with higher accuracy by detecting deformation of each of the multiple beam portions 114a and 114b by using the multiple strain detecting sensors 121.

Upon application of a torque to the strain generator 110 in one rotational direction, one of the beam portions 114a and 114b is deformed in the extending direction and the other is deformed in the shrinking direction. Accordingly, the polarity of the detection value of the strain detecting sensor 121 provided on one of the beam portions 114a and 114b differs from the polarity of the detection value of the strain detecting sensor 121 provided on the other of the beam portions 114a and 114b.

(Relationship Between the Protrusion 133B and the Groove 111C)

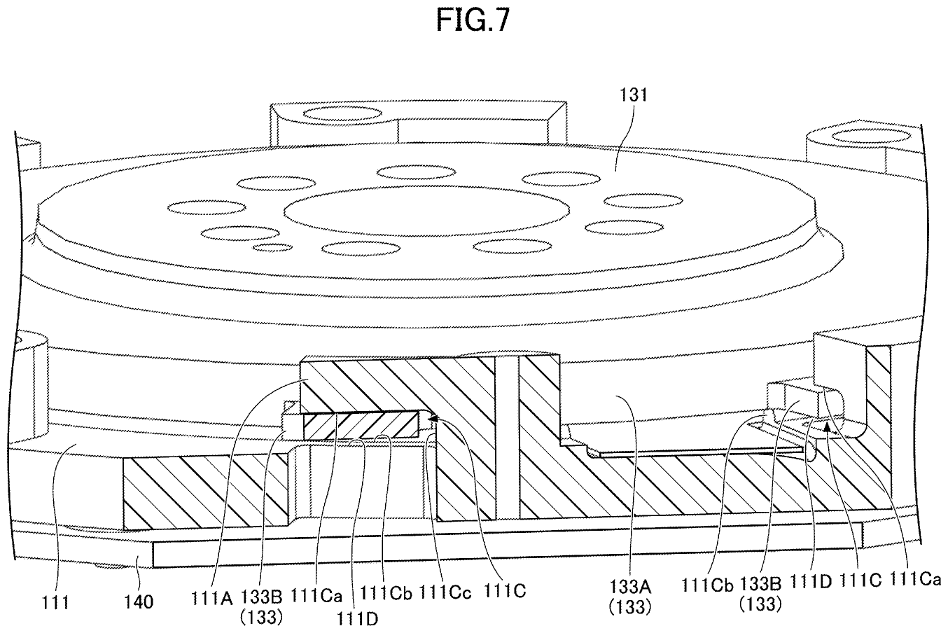

FIG. 7 is a partially enlarged cross sectional view of the force sensor device 100 according to an embodiment. As illustrated in FIG. 7, the protrusion 133B of the regulator 133 is inserted into the groove 111C provided in the first fixed part 111 of the strain generator 110. The protrusion 133B faces a counter-face portion 111D, which is the bottom surface of the groove 111C. As illustrated in FIG. 7, in the vertical direction, the protrusion 133B of the regulator 133 is clamped between an upper surface 111Ca and a lower abutment 111Cb of the groove 111C provided in the first fixed part 111 of the strain generator 110 to regulate its movement in the vertical direction. With this, the regulator 133 suppresses the vertical deformation (i.e., the deformation that should not be detected) of the strain generator 110. In this regard, as illustrated in FIG. 7, the protrusion 133B of the regulator 133 is released from the groove 111C in one direction (clockwise direction) in the rotational direction, and the protrusion 133B is separated from a side wall 111Cc of the groove 111C in the other direction (the counterclockwise direction) in the rotational direction, so that the protrusion 133B is allowed to move both directions of the rotational direction. With this, the regulator 133 allows defamation in the rotational direction of the strain generator 110 (i.e., the deformation to be detected). The lower abutment 111Cb is convex toward the upper surface 111Ca, and the lower abutment 111Cb extends in a rib-like shape on the same circumference.

(Operation of the Force Sensor Device 100 According to an Embodiment)

In the force sensor device 100 configured as described above, in response to rotation of the transmitting member (the rotating body) secured to one of the first fixed part 111 and the second fixed part 112 of the strain generator 110, the transmitted member (the rotating body) secured to the other of the first fixed part 111 and the second fixed part 112 of the strain generator 110 also rotates via the strain generator 110. At that time, according to the torque applied to the strain generator 110, deformation occurs in the joining part 113 of the strain generator 110. In particular, in the joining part 113, each of the multiple beam portions 114a and 114b is narrower than the other parts, so that deformation tends to occur more easily than the other parts. Thus, the force sensor device 100 according to an embodiment detects deformation of each of the multiple beam portions 114a and 114b by using the multiple strain detecting sensors 121. As a result, the force sensor device 100 according to the embodiment can detect the torque applied to the strain generator 110 with higher accuracy.

As described above, the force sensor device 100 according to an embodiment includes the strain generator 110 including the first fixed part 111 secured to a portion transmitting rotational driving force or a portion to which the rotational driving force is transmitted, the second fixed part 112 secured to the portion transmitting the driving force or the portion to which the driving force is transmitted, and the joining part 113 that joins the first fixed part 111 to the second fixed part 112; and the strain detecting sensor 121 that detects deformation in the joining part 113 of the strain generator, wherein the first fixed part 111 is disposed outside the second fixed part 112 across the joining part 113, wherein the force sensor device 100 further includes the support member 130 provided with the base 131 secured to one of the first fixed part 111 or the second fixed part 112, wherein the support member 130 includes the regulator 133 extending from the base 131, and wherein, in a case where the base 131 is secured to one of the first fixed part 111 or the second fixed part 112, the regulator 133 allows a rotational motion of the strain generator 110 while regulating a motion other than the rotational motion of the strain generator 110.

As described above, the force sensor device 100 according to the embodiment includes the support member 130 secured to one of the first fixed part 111 or the second fixed part 112, so that the load applied from the transmitting part to the strain generator 110 can be reduced compared with the case where the strain generator 110 alone transmits the rotational driving force or the strain generator 110 alone is fixed to the transmitted part to which the driving force is transmitted. Accordingly, the entire strain generator 110 can be reinforced. Furthermore, the force sensor device 100 according to the embodiment allows the rotational motion of the strain generator 110 by the regulator 133 of the support member 130, while the force sensor device 100 can regulate the motion other than the rotational motion of the strain generator 110, such as torsion, so that the generation of defamation associated with the motion other than the rotational motion of the strain generator 110 in the joining part 113 of the strain generator 110 can be suppressed. Accordingly, the force sensor device 100 according to the embodiment can accurately detect the driving force (torque) of rotation by using the strain detecting sensor 121. Thus, the force sensor device 100 according to the embodiment can provide an accurate force sensor device in which sufficient strength is ensured.

Furthermore, in the force sensor device 100 according to the embodiment, the first fixed part 111, the base 131 not secured the first fixed part 111, may include the counter-face portion 111D facing the regulator 133 with a gap.

As a result, in the force sensor device 100 according to the embodiment, the regulator 133 faces the counter-face portion 111D of the first fixed part 111, so that the regulator 133 faces the portion transmitting the rotational driving force or the portion to which the driving force is transmitted, and the motion of the strain generator 110 other than the rotational motion, such as torsion, can be directly regulated. As a result, the force sensor device 100 according to the embodiment can surely suppress an occurrence of deformation associated with the motion of the strain generator 110 other than the rotational motion in the joining part 113 of the strain generator 110. Thus, the force sensor device 100 according to the embodiment can accurately detect the driving force (torque) of rotation by using the strain detecting sensor 121.

Furthermore, in the force sensor device 100 according to an embodiment, the counter-face portion 111D may be provided on the bottom surface of the groove 111C formed in the first fixed part 111, the regulator 133 may be provided with the protrusion 133B accommodated in the groove 111C, and a gap may be provided between the protrusion 133B and the side wall 111Cc of the groove 111C.

Thus, in the force sensor device 100 according to the embodiment, the protrusion 133B of the regulator 133 is accommodated in the groove 111C provided with the counter-face portion 111D facing the protrusion 133B with a gap between the protrusion 133B and the side wall 111Cc. Accordingly, the movement of the force sensor device 100 can be regulated even if excessive rotational movement or large deformation of the strain generator 110 occurs. As a result, the force sensor device 100 according to the embodiment can more reliably suppress an occurrence of deformation associated with excessive rotational motion or a motion other than the rotational motion of the strain generator 110 in the joining part 113 of the strain generator 110. Thus, the force sensor device 100 according to the embodiment can accurately detect the driving force (torque) of rotation by using the strain detecting sensor 121.

In addition, in the force sensor device 100 according to the embodiment, the regulator 133 can allow the rotational motion of the strain generator 110 and the regulator 133 can regulate a motion other than the rotational motion of the strain generator 110 with a relatively simple configuration. Accordingly, the force sensor device 100 according to the embodiment can enhance the manufacturability of the force sensor device 100, reduce the cost of the force sensor device 100, and detect the rotational driving force with high accuracy.

Furthermore, in the force sensor device 100 according to an embodiment, the regulator 133 may be provided with the flat plate part 133A parallel to the joining part 113, and the flat plate part 133A may be provided a gap with the joining part 113.

As a result, in the force sensor device 100 according to the embodiment, the flat plate part 133A of the regulator 133 and the joining part 113 of the strain generator 110 face each other with a gap, so that the rotational motion of the strain generator 110 (the joining part 113) can be allowed, while a large motion other than the rotational motion of the joining part 113, such as large torsion, can be regulated. Accordingly, excessive deformation of the joining part 113 can be suppressed, and the joining part 113 (the strain generator 110) can be reinforced.

In the force sensor device 100 according to an embodiment, the joining part 113 may be thinner than the first fixed part 111 and the second fixed part 112.

Thus, in the force sensor device 100 according to the embodiment, the rigidity of the joining part 113 can be lower than that of the first fixed part 111 and the second fixed part 112, so that the joining part 113 can be easily deformed upon application of rotational driving force. Accordingly, even if the applied rotational driving force is small, the driving force can be accurately and precisely detected.

In the force sensor device 100 according to an embodiment, the strain generator 110 may be formed of a resin material.

As a result, in the force sensor device 100 according to the embodiment, the strain generator 110 can be relatively easily formed and the weight of the strain generator 110 can be reduced. Accordingly, the weight of the entire force sensor device 100 according to the embodiment can be reduced, and the cost of the force sensor device 100 can be reduced.

In the force sensor device 100 according to an embodiment, the rigidity of the joining part 113 may be lower than that of the first fixed part 111 and the second fixed part 112.

As a result, in the force sensor device 100 according to the embodiment, the rotational driving force can be made difficult to escape at the first fixed part 111 and the second fixed part 112, so that almost all the rotational driving force can be transmitted to the joining part 113, and the joining part 113 can be easily defamed. Accordingly, the force sensor device 100 according to the embodiment can accurately detect the driving force even if the applied rotational driving force is small.

Furthermore, in the force sensor device 100 according to an embodiment, the strain detecting sensor 121 may be a sensor that detects deformation in terms of a change in a resistance value.

Thus, the force sensor device 100 according to the embodiment can detect deformation in the joining part 113 by detecting the voltage value based on the change in the resistance value of the strain detecting sensor 121. Accordingly, the force sensor device 100 according to the embodiment can detect the rotational driving force with high accuracy by the relatively simple configuration.

In the force sensor device 100 according to an embodiment, the first fixed part 111 may be annularly shaped and the second fixed part 112 may be annularly arranged, and the center of the annularly shaped first fixed part 111 may coincide with the center of the annularly arranged second fixed part 112.

As a result, in the force sensor device 100 according to the embodiment, a loss of the rotational driving force between the first fixed part 111 and the second fixed part 112 can be suppressed by providing the first fixed part 111 and the second fixed part 112 coaxially. Accordingly, the force sensor device 100 according to the embodiment can efficiently transmit the rotational driving force through the force sensor device 100. In addition, in the force sensor device 100 according to the embodiment, the rotational driving force can be efficiently applied to the joining part 113.

In the force sensor device 100 according to an embodiment, a plurality of strain detecting sensors 121 may be provided, and the plurality of strain detecting sensors 121 may be annularly arranged.

As a result, the force sensor device 100 according to the embodiment can detect multiple deformation values on the same circumference at the joining part 113. Accordingly, the force sensor device 100 according to the embodiment can detect the rotational driving force (torque) with higher accuracy by the detected values (i.e., the detected defamation values at the multiple locations in the joining part 113) of the multiple strain detecting sensors 121. In addition, the force sensor device 100 according to the embodiment can calculate the rotational driving force with high accuracy based on the detected values of other strain detecting sensors 121, even if, for example, a failure or an abnormal value occurs in some strain detecting sensors 121.

Furthermore, in the force sensor device 100 according to an embodiment, the joining part 113 may be provided with a plurality of through holes 113A and 113B arranged in a ring shape.

As a result, in the force sensor device 100 according to the embodiment, the weight of the joining part 113 can be reduced and the rigidity of the joining part 113 can be moderately reduced, so that the joining part 113 can be easily deformed. Accordingly, the force sensor device 100 according to the embodiment can accurately detect the driving force, even if the applied rotational driving force is small.

In the force sensor device 100 according to an embodiment, the joining part 113 may be provided with a plurality of beam portions 114a and 114b famed by providing a plurality of through holes 113 A and 113 B, and each of the plurality of beam portions 114a and 114b may be provided with the strain detecting sensor 121.

Thus, the force sensor device 100 according to the embodiment can detect deformation in each of the plurality of beam portions 114a and 114b at which the rigidity is locally lowered. Accordingly, the force sensor device 100 according to the embodiment can accurately detect the driving force, even if the applied driving force is small.

In the force sensor device 100 according to an embodiment, the strain generator 110 may be provided with the through hole 112B at the center, through which wiring may be inserted.

Thus, the force sensor device 100 according to the embodiment can prevent the wiring from being exposed outside the strain generator 110. As a result, the force sensor device 100 according to the embodiment can be made less likely to cause a defect, such as a wire tangle or a disconnection in the wire.

In addition, the force sensor device 100 according to an embodiment may have a shape corresponding to the shape of the joining part 113, and the force sensor device 100 may further include the flexible board 120 stacked on the surface of the joining part 113, and the strain detecting sensor 121 may be implemented on the flexible board 120.

Thus, in the force sensor device 100 according to the embodiment, the strain detecting sensors 121 can be placed at predetermined positions by placing the flexible board 120 on the surface of the joining part 113. Accordingly, the force sensor device 100 according to the embodiment can easily and reliably arrange the strain detecting sensors 121.

Although the embodiments of the present disclosure are described in detail above, the present disclosure is not limited to the embodiments, and various alterations and modifications may be made within the scope of the gist of the present disclosure as set forth in the claims.

For example, the configuration of the joining part 113 is not limited to the configuration described in the embodiments. That is, the joining part 113 may have any configuration as long as it is configured so that at least deformation of the joining part 113 can be detected by the strain detecting sensor 121.

For example, in the embodiments, the strain detecting sensor 121 may be arranged on a surface facing the support member 130 in the strain generator 110, but the arrangement of the strain detecting sensor 121 is not limited to this configuration. The strain detecting sensor 121 may be arranged on a surface facing the circuit board 140 in the strain generator 110.

In addition, in the embodiments, the protrusion 133B may be provided in the support member 130 and the groove 111C may be provided in the first fixed part 111, but the configuration of the strain generator 110 is not limited to this. For example, a protrusion may be provided in the first fixed part 111 and a groove may be provided in the support member 130. For example, a protrusion may be provided in the support member 130, and a groove may be provided in the second fixed part 112. For example, a protrusion may be provided in the second fixed part 112 and a groove may be provided in the support member 130.

What is claimed is:

1. A force sensor device comprising:
a strain generator including a first fixed part secured to a portion transmitting rotational driving force or a portion to which the rotational driving force is transmitted, a second fixed part secured to the portion to which the driving force is transmitted or the portion transmitting the driving force, and a joining part that joins the first fixed part to the second fixed part; and
a strain detecting sensor that detects deformation in the joining part of the strain generator,
wherein the first fixed part is disposed outside the second fixed part across the joining part,
wherein the force sensor device further includes a support member provided with a base secured to the second fixed part,
wherein the support member includes a regulator extending from the base,
wherein the support member is provided with a protrusion at an outer circumferential edge of the regulator,
wherein, in a support part that is a partially raised portion of the first fixed part, a groove is formed by cutting the support part from an inner surface in a radial direction toward an outer surface in the radial direction, and
wherein the protrusion of the support member is inserted into the groove.

2. The force sensor device according to claim 1, wherein a vertical width of the groove is the same as a vertical width of the protrusion of the support member.

3. The force sensor device according to claim 1, wherein the groove opens in a rotation direction, and
wherein a gap is provided between the protrusion and a side wall of the groove.

4. The force sensor device according to claim 1, further comprising:
a flexible board stuck on a surface of the joining part, the flexible board having a shape that is the same as a shape of the joining part,
wherein the strain detecting sensor is implemented on the flexible board,
wherein the regulator is provided with a flat plate part, and
wherein the flexible board is provided between the flat plate part of the support member and the joining part.

5. The force sensor device according to claim 1, wherein the strain generator is formed of a resin material,
wherein the joining part is thinner than the first fixed part and the second fixed part, and
wherein the support member is formed of a metal material or a resin material with rigidity that is higher than rigidity of the strain generator.

6. The force sensor device according to claim 1, wherein multiple through holes are formed in the first fixed part, each of the multiple through holes vertically passes through the corresponding support part of the first fixed part,
wherein the first fixed part is secured to one of the portion transmitting the rotational driving force or the portion to which the rotational driving force is transmitted by using bolts that pass through the corresponding through holes of the first fixed part,
wherein multiple through holes are famed in the second fixed part, each of the multiple through holes vertically passes through the second fixed part, and
wherein the second fixed part is secured to one of the portion to which the rotational driving force is transmitted or the portion transmitting the rotational driving force by using bolts that pass through the corresponding through holes of the second fixed part.

7. The force sensor device according to claim 6, wherein through holes are formed in the base of the support member, and
wherein the support member is secured to the second fixed part by using the bolts that pass through the corresponding through holes of the support member and the corresponding through holes of the second fixed part.

8. The force sensor device according to claim 1, wherein the strain detecting sensor is a sensor configured to detect deformation in terms of a change in a resistance value.

9. The force sensor device according to claim 1, wherein the first fixed part has an annular shape,
wherein the second fixed part has an annular shape,
wherein a center of the annular first fixed part coincides with a center of the annularly arranged second fixed part,
wherein multiple strain detecting sensors are annularly arranged,
wherein the joining part is provided with a plurality of through holes arranged annularly, and
wherein the joining part is provided with a plurality of beam portions formed by providing the plurality of through holes, and each of the plurality of beam portions is provided with the strain detecting sensor.

10. The force sensor device according to claim 1, wherein the strain generator is provided with a through hole at a center of the strain generator, and
wherein wiring is inserted into the through hole at the center of the strain generator.
